(19) United States
(12) Patent Application Publication
(10) Pub. No.: US 2009/0125229 A1
(43) Pub. Date: May 14, 2009

(54) Corridor mapping with alternative routes

(75) Inventors: Omer Shmuel Peri, Raanana (IL); Noam Sagi, Tel Aviv (IL); Tali Zvi, Givatayim (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: TELMAP, LTD., Herzlia (IL)

(21) Appl. No.: 11/985,126

(22) Filed: Nov. 14, 2007

(51) Int. Cl. G01C 21/34

(52) U.S. Cl. 701/201

(57) ABSTRACT

A navigation system computes an optimal route between an origin and a destination using a map server. The map server identifies likely points of deviation from the optimal route, and prior to transmitting map data to a client device, establishes alternative optimal routes from the deviations to the destination. A search algorithm is employed in which computation effort is reduced through improved heuristics and enhanced recognition of previously expanded nodes and alternative routes through nodes determined in prior iterations of the search. A route corridor map including the optimal route and alternative routes is download from the map server to the client device.

### BACKGROUND OF THE INVENTION

1. Field of the Invention

This invention relates generally to methods and systems for electronic download and display of route maps. More particularly, this invention relates to management of deviations from a calculated route map.

2. Description of the Related Art

A variety of systems are known in the art for providing drivers with in-vehicle electronic routing maps and navigation aids. These systems are commonly coupled to a location-finding device in the vehicle, such as a Global Positioning System (GPS) receiver. The GPS receiver automatically determines the current location of the vehicle, to be displayed on the map and used in determining routing instructions.

In-vehicle navigation systems fall into two general categories: “on-board” systems, in which the map data are stored electronically in the vehicle (typically on optical or magnetic media); and “off-board” systems, in which the map data are furnished by a remote map server. Off-board systems typically use a client program running on a smart cellular telephone or personal digital assistant (PDA) in the vehicle to retrieve information from the server over a wireless link, and to display maps and provide navigation instructions to the driver.

Various off-board navigation systems are described in the patent literature. For example, U.S. Patent Application Publication No. 2004/0030493 (Pechatnikov et al.), whose disclosure is incorporated herein by reference, describes a method for displaying a map on a mobile client device. Map data, including vector information delineating features in the map, are stored on a server. The server determines a route from a starting point to a destination within an area of the map. The route includes a sequence of route segments, each having a respective length and heading angle. The server then defines a corridor map comprising a sequence of map segments, each of which contains a respective route segment and has a respective zoom level and orientation determined by the length and heading angle of the route segment. The server downloads the vector information in the map segments to the client device, which renders a succession of images of the map segments as the user travels along the route. Typically, each map segment includes crossroads that intersect the route. If the user deviates from the route, the client device displays a return path to the route on one of the crossroads.

U.S. Patent Application Publication No. 2006/0025923 (Dotan et al.), whose disclosure is incorporated herein by reference, describes a method for displaying a map on a mobile client device. The method includes storing map data on a server, the map data including road data with respect to roads of multiple different road types. The server determines a route from a starting point to a destination within an area covered by the map data, the route including one or more route segments. The server defines a corridor map including the route segments and the roads of the different road types that are within different, respective distances, determined by the road types, of the route segments. The server downloads the road data with respect to the route segments and the roads of the different road types included in the corridor map to the client device. The client device, using the downloaded road data, renders one or more images, each image comprising at least a respective portion of the corridor map.

As another example, U.S. Pat. No. 6,381,535, whose disclosure is incorporated herein by reference, describes improvements required to convert a portable radiotelephone into a mobile terminal capable of functioning as a navigational aid system. Itinerary requests of the mobile terminal are transmitted to a centralized server by a radio relay link. The server calculates the itinerary requested, and transmits the itinerary to the mobile terminal in the form of data concerning straight lines and arc segments constituting the itinerary. The server also evaluates the possibility of the vehicle deviating from its course, and transmits data concerning segments of possible deviation itineraries in an area of proximity to the main itinerary.

Other off-board navigation systems are described in PCT Publications WO 01/01370 and WO 01/27812; in U.S. Pat. Nos. 6,038,559, 6,107,944, 6,233,518, 6,282,489, 6,320,518, 6,347,278, 6,462,676, 6,43,630, 6,526,284 and 7,142,205. The disclosures of all these patents and publications are incorporated herein by reference.

### SUMMARY OF THE INVENTION

In order to assist the user of a navigation system in recovering from a deviation from the originally planned route, it is desirable to present the user with a complete, accurate picture of all the roads in the vicinity of the route. Off-board navigation systems, however, are subject to bandwidth constraints, which limit the amount of map data that can be transmitted over the air from a server to a user's client device. Therefore, the amount of ancillary road data that can be downloaded along with the actual route is limited.

There is a possibility that the user may deviate from the original route to a new position, such that the best alternative route from the new position to the destination takes the user a long way from the original route. Furthermore, the user may deviate from the alternative route, requiring a new alternative route, and so on. Conventional systems would either require additional communication between the server and the user's client device, or the use of a non-optimal alternative route. Calculating an optimal route from every possible deviation is generally not feasible, since the time and resources required to compute all possible alternative routes would not be reasonable.

An error-prone junction is a location where two or more roads intersect in which there is a high probability that the user will make a mistake in attempting to follow the prescribed instructions. Embodiments of the invention use statistical analysis based on a large set of previously traversed routes, in order to identify error-prone junctions. Error-prone junctions are considered likely deviations. Embodiments of the invention also use statistical analysis to identify types of junctions as error-prone.

Embodiments of the present invention define a corridor around the optimal calculated route taking into account various deviations from the main route. When a user deviates from the calculated route, but remains within the corridor, he continues to be directed to his destination via an alternative optimal route to the destination from his deviant location, without need to access the server for more information. Data from points along the route at which the user is likely to deviate from a prescribed route are used for calculation of respective optimal alternative routes from each likely deviation. This is repeated, recursively, for each alternative route calculated.

Embodiments of the invention also identify junctions at which deviations are likely to occur by analyzing their complexity. The complexity of the junction depends on many factors, including the number of streets meeting at the junction and the angles between the streets.

Every user has a unique driving pattern. Some users prefer highways to smaller city level streets while others avoid highways as much as possible. Some users prefer to take shortcuts through paved roads while others prefer to follow major city streets. Embodiments of the invention analyze the specific driving patterns of the user, by reviewing his or her tendency to follow the optimal route calculated, in order to predict likely deviations by the user.

Occasionally there are two or more possible routes to reach a destination where it is hard to determine the optimal one. In these cases, it is likely that all possible routes will be used evenly among users. Embodiments of the invention treat the alternative routes as likely deviations.

The server calculates and downloads optimal routes to the client device, together with map data for other roads and features near the optimal and alternative routes. This is done prior to downloading map data to the client. The algorithm used to calculate the optimal routes is efficient, and allows calculations for the optimal route from a first deviation to be reused when calculating the optimal route from a second deviation. As a consequence, optimal routes from many deviations may be calculated in a reasonable amount of time.

An embodiment of the invention provides a method for preparing a route map, which is carried out by communicating an origin and a destination to a server, and in the server establishing a prescribed route that extends from the origin to the destination. The method is further carried out by identifying junctions in the route where a traveler is likely to deviate from the prescribed route, and establishing alternative routes to the destination extending from points of departure that are associated with the deviations. The method is further carried out by thereafter downloading map data from the server to a client device, the map data including a route corridor that includes the prescribed route and the alternative routes, and rendering at least a portion of the map data on the client device. The server and client need not communicate between the time a route is requested and the final map data downloaded.

According to an aspect of the method, the alternative routes are optimal alternative routes.

An additional aspect of the method includes prior to performing downloading map data, selecting deviations along the alternative routes and responsively thereto, establishing new alternative routes.

In one aspect of the method, establishing alternative routes is performed by choosing the deviations according to a sort order. The sort order may include remoteness of the deviations from the destination, wherein a first chosen one of the deviations is a most remote deviation from the destination, and the establishment of alternative routes includes a search beginning at the destination and terminating at the points of departure, respectively.

Another aspect of the method includes specifying points of interest, and choosing the deviations only from junctions that are disposed within a predetermined distance of the points of interest.

According to a further aspect of the method, the deviations comprise a first order of deviation on the prescribed route.

According to yet another aspect of the method, the deviations comprise a higher order of deviation on the alternative routes.

One aspect of the method includes collecting records of actual deviations executed in at least a portion of the junctions, and selecting deviations is performed using the records.

An aspect of the method includes compiling a profile of the traveler, the profile including preferences for functional classes of roads, wherein selecting deviations is performed responsively to the profile.

In a further aspect of the method, selecting deviations is performed responsively to proximity between a candidate junction and other junctions.

In yet another aspect of the method, selecting deviations is performed responsively to a number of intersecting roads at the junctions.

In still another aspect of the method, selecting deviations is performed responsively to an angle of intersection at the junctions.

Other embodiments of the invention provide computer software product and apparatus for carrying out the above-described method.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a simplified pictorial illustration of a real-time map distribution and display system constructed and operative in accordance with an embodiment of the present invention;

FIG. 2 is a flow chart that schematically illustrates a method for generating a corridor map with alternative routes, in accordance with an embodiment of the present invention;

FIG. 3 is a map that illustrates an optimal route from an origin to a destination generated by the system of FIG. 1, in accordance with an embodiment of the present invention;

FIG. 4 is a map that illustrates a deviation from the optimal route of FIG. 3, generated by the system of FIG. 1, in accordance with an embodiment of the present invention;

FIG. 5 is a block diagram of a node used to construct a corridor map, in accordance with an embodiment of the present invention;

FIG. 6, FIG. 7, and FIG. 8 are maps that illustrate a method of calculating alternative routes in accordance with an embodiment of the present invention; and

FIG. 9 is an overview corridor map of a part of the optimal route of FIG. 3, as shown on the display of FIG. 1, in accordance with an embodiment of the present invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

### System Overview.

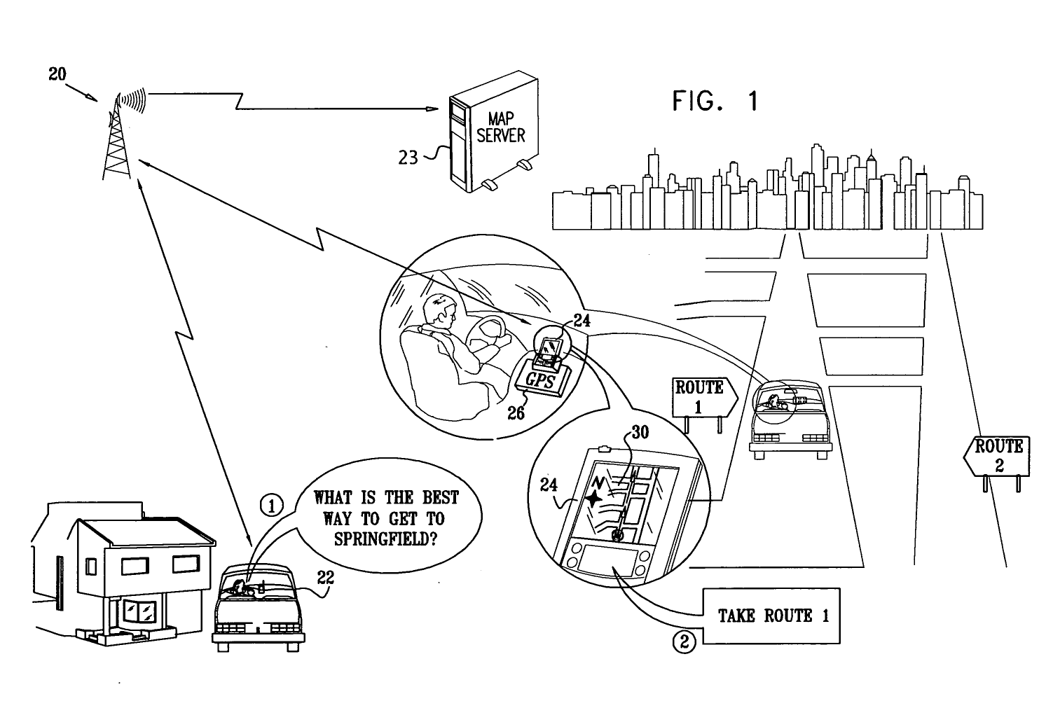

Turning now to the drawings, reference is initially made to FIG. 1, which is a simplified pictorial illustration of a real-time map distribution and display system 20, constructed and operative in accordance with an embodiment of the present invention. A driver of a vehicle 22 communicates with a map server 23 via a client device 24, typically a wireless communicator, such as a personal digital assistant (PDA) having cellular telephone functionality or a smart cellular telephone. Client device 24 may communicate with map server 23 over the internet. In some embodiments of the invention, client device 24 communicates with map server 23 via an interactive voice response (IVR) processor. A traveler, typically the driver of vehicle 22 is also sometimes referred to as a user of client device 24.

Map server 23 may be a general-purpose computer, comprising a memory in which map data are stored and a processor, which carries out the methods described herein under the control of software. The software may be downloaded to the processor in electronic form, over a network, for example, or it may alternatively be provided on tangible media, such as CD-ROM, DVD, magnetic media or non-volatile memory.

A location data output is provided by a GPS receiver 26 or other locating device in vehicle 22, and the location is transmitted automatically by client device 24 to map server 23. Alternatively, a cellular network with which client device 24 communicates may provide the location data output to map server 23, or the user may supply location data via the client device.

In the illustrated embodiment, the driver of vehicle 22 asks for current directions and a map showing a route from his current location to a given destination. Map server 23 computes the optimal route to the destination, as well as possible alternative routes to be followed in case vehicle 22 deviates from the optimal route. For example, assuming the original route to the destination to be Route 1, as shown in FIG. 1, the user may mistakenly turn right off the route. In this case, map server 23 may have calculated that the best route to the destination is a left turn onto Route 2, which is then followed toward the destination rather than an attempt to return to Route 1.

Map server 23 then generates a corridor map showing the optimal route. A corridor map comprises a sequence of map segments, each of which contains a respective route segment and has a respective zoom level and orientation determined by the length and heading angle of the route segment. The corridor map produced by the map server 23 comprises map data, typically in the form of vector data, which delineates the route, along with the alternative routes and other roads in the vicinity of the route and the alternative routes. Based on the map data, a client program running on client device 24 renders a map showing the optimal route on a display 30. Methods for generating a corridor map using vector data, and for rendering the map on a client device, are described further in the above-mentioned U.S. Patent Application Publication No. 2006/0025923. In system 20, the roads to be included in the map data are chosen based on the road types and the distances of the roads from the route, or an alternative route, wherein different maximum distances for road inclusion are applied to different road types.

Typically, client device 24 outputs navigation instructions to the driver, based on the optimal route calculated by map server 23. The navigation instructions are generally shown on display 30 along with the map, and they may also be annunciated by the client device using text-to-speech functionality.

Route Deviations.

During or after construction of optimal route 101, map server 23 proceeds to determine possible deviations from the route, which are stored in a list of deviations. For purposes of alternative route calculation, a “deviation” is defined as a segment, sometimes termed a “deviant segment”, leading from a junction in the optimal route to a junction in a deviant route. In the context of FIG. 1, a deviation is a turn that deviates from the route provided by map server 23.

A deviation from the originally prescribed route is called a “first order of deviation”. A deviation from a route consequent to a first order of deviation is called a “second order of deviation”. Third, fourth and subsequent levels of deviation are similarly defined. Orders of deviation other than a first order of deviation are referred to as a “higher order of deviation”. Deviations of any order are identified by the map server 23 as those considered likely to occur. Deviations considered unlikely to occur are ignored in order to avoid an impractical number of route computations.

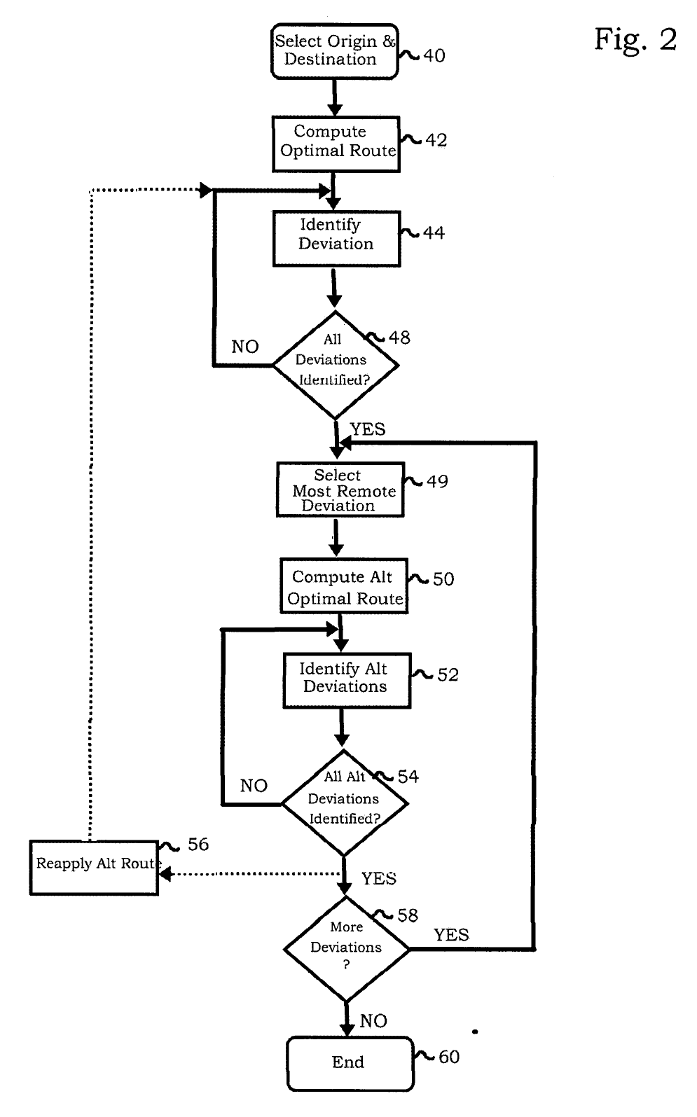

Reference is now made to FIG. 2, which is a flow chart illustrating a method of constructing a route map for display on a map on a mobile client device in accordance with a disclosed embodiment of the invention. The process steps are shown in a particular linear sequence in FIG. 2 for clarity of presentation. However, it will be evident that many of them can be performed in parallel, asynchronously, or in different orders. For example, identification and processing of deviations are shown separately, but may be performed concurrently with the preparation of an optimal route map or alternative optimal route map. At initial step 40, a route origin and destination are selected.

At step 42 an optimal route map is computed from the origin to the destination, using the source and destination chosen in initial step 40. Calculation of the optimal route can be done bi-directionally. Alternatively, it may be calculated unidirectionally.

The methods described in the above-noted U.S. Patent Application Publication No. 2006/0025923 are suitable for preparing the optimal route map and a corridor map based on the optimal route and alternative routes. To summarize briefly, client device 24 submits a route request that specifies various input data, such as the starting location (provided by manual input or automatically) and destination, as well as any interim locations to be passed along the route. The user may also specify a choice of optimal route type (shortest, fastest or simplest), as well as the transport type (car, truck, bicycle, pedestrian), and any road types to avoid, for example, toll roads. Map server 23 then computes the route, using any suitable automatic routing algorithm known in the art, such as the A*, Floyd-Warshall or Dijkstra algorithms. Such algorithms are described, for example, by Cherkassky et al., in “Shortest Path Algorithms: Theory and Experimental Evaluation,” Technical Report 93-1480, Department of Computer Science, Stanford University (Stanford, Calif., 1993), which is incorporated herein by reference.

The A* algorithm has been found to be particular suitable. This is a well known search algorithm that finds a path from a given initial node of a graph to a given goal node, using a heuristic estimate that ranks each node by an estimate of the best route that goes through that node, and expands the nodes in order of the heuristic estimate. Provided that the heuristic estimate is not an overestimate, the A* algorithm always finds the best route. Aerial distance satisfies this condition, since the aerial distance between two points cannot exceed the distance by road, and is easily and quickly calculated without requiring expansion of nodes. The A* algorithm employs a priority queue in order to keep track of unexplored routes. Typically, a route for which a lower bound on the total path length is smallest is given highest priority. Route exploration corresponds to expansion of nodes that represent road junctions.

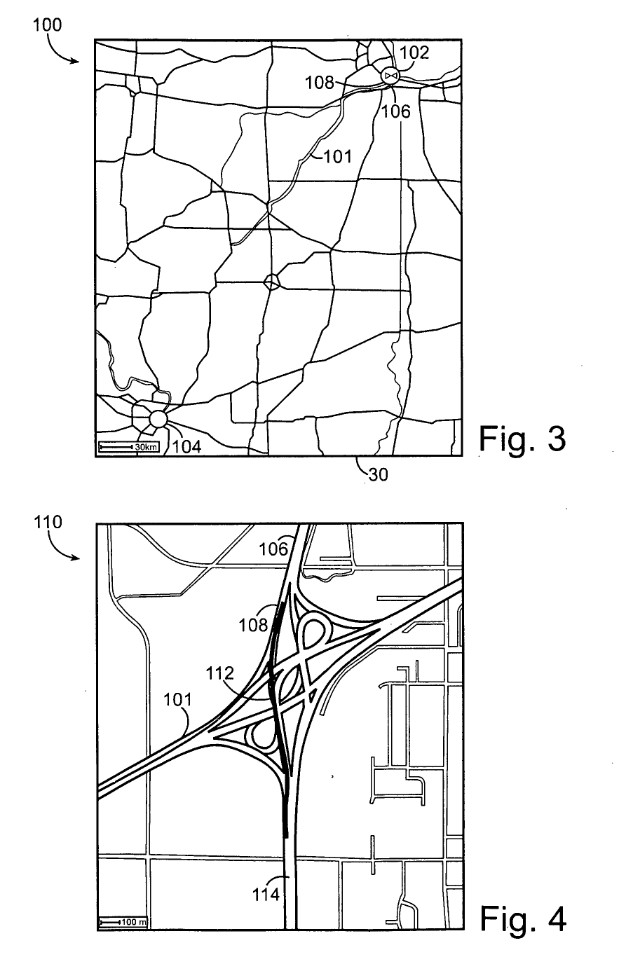

Reference is now made to FIG. 3, which is a map 100 that illustrates an optimal route 101 from an origin 102 to a destination 104 generated by system 20 (FIG. 1), as shown on display 30, in accordance with an embodiment of the present invention. Optimal route 101 comprises a sequence of roads, which run between junctions and the origin and destination. For example, a road 106 runs between origin 102 and a junction 108.

Referring again to FIG. 2, at step 44 a deviation arising from an error-prone junction is identified on the route map that was constructed in step 42. Step 44 may be performed using one or more techniques in many combinations. These techniques are described below. Should the user actually deviate from the optimal route at the deviation chosen in step 44, it is assumed that it is not necessarily convenient to return to the optimal route. However, a return to the optimal route is not precluded, should it prove to be a superior alternative. Typically, the junction in the deviant route is the first junction encountered. The deviant segment is assigned a direction leading generally away from the optimal route. When an alternative optimal route is calculated, it extends from the deviant segment to the original destination. The deviant segment and its associated data are memorized, typically by adding the current deviation to a list of deviations.

Control now proceeds to decision step 48, where it is determined if all deviations on the optimal route have been identified. If the determination at decision step 48 is negative, then control returns to step 44. The process steps beginning with step 44 are performed recursively to identify higher order deviations—that is deviations on alternative routes, as explained below. The term “recursion” is used simply to facilitate understanding of the method. Efficient implementations of the method that avoid recursive calls will occur to those skilled in the art.

If the determination at decision step 48 is affirmative, then control proceeds to step 49. It is an aspect of the invention that at least one interaction between the map server and the mobile client device is required between initial step 40 and step 42. However, no further server access by the client device is necessary until the completed corridor map is downloaded to the client device.

At step 49 the deviation most remote from the destination in the optimal route is chosen. The measure of remoteness is typically the aerial distances from a deviation to the destination. Alternatively, other indicators of remoteness may be used, e.g., distance measured by traversals of the optimal route, estimated travel time. Choosing the deviations in sort order by remoteness is an important aspect of the invention. As will be seen from the discussion below, a portion of the deviations, as well as other nodes on the route or alternative routes, may be re-encountered. Once it is recognized that an optimal route from a node, including a deviation, to the destination is known, all its previous alternative route computations can be reused and need not be repeated. Selecting deviations in sort order has the effect of maximizing encounters of previously computed deviations, thereby increasing the efficiency of the method.

Reference is now made to FIG. 4, which is a map 110 that illustrates a deviation from optimal route 101, as shown on display 30, in accordance with an embodiment of the present invention. Instead of continuing along optimal route 101 (generally toward the lower left portion of the map), the driver of vehicle 22 may instead bear left at junction 108 onto a road 112, as shown in FIG. 4. Map server 23 has anticipated this possibility, and has calculated an alternative route 114, included as part of the corridor map, from junction 108 to destination 104. It will be appreciated that in many cases, the design of a highway system such as shown in FIG. 4 may not permit a convenient return to junction 108.

Referring again to FIG. 2, in step 50 an alternative optimal route is computed between the new point of departure chosen in step 44 and the destination. This should be done in a reverse direction, beginning from the destination and ending at the new point of departure. The above-noted A* algorithm is suitable for this step. The route is stored in the data structure associated with the currently selected deviation.

Alternatively, the deviation closest to the destination could be selected in step 49, in which case the alternative routes are computed in a forward direction in step 50. This and other options for performing step 50 are described below in the sections dealing with alternative embodiments of the invention.

In step 52, which is performed after step 50 has been completed, second or higher order deviations are identified on the alternative optimal route that was computed in step 50, using the same techniques as in step 44. As noted above, detection of such deviations in a reverse direction as the A* algorithm progresses contributes to the efficiency of the algorithm, as the same deviations are more likely to be repeatedly encountered during recursions. When a re-identification of such a deviation is recognized, alternative optimal routes (and their respective deviations) from the re-identified points will already have been computed. Of course, these computations need not be repeated.

Control now proceeds to decision step 54, where it is determined if all alternative deviations on the current alternative optimal route have been identified. If the determination at decision step 54 is negative, then control returns to step 52.

If the determination at decision step 54 is affirmative, then control proceeds in two directions. First, the sequence beginning at step 44 is performed at a higher level of recursion, reapplying the current alternative optimal route at step 56. This is shown by in FIG. 2 by broken lines. Recursion may terminate when the current set of deviations is exhausted. Additional conditions for terminating recursion include a predefined order of deviation, total number of calculated nodes, data storage limit, and time limit. Many parallel implementations are possible, for example, multiple threads.

Second, control passes to decision step 58, where it is determined if more alternative deviations in alternative route at the current level of recursion need to be processed.

If the determination at decision step 58 is affirmative, then control returns to step 49. Otherwise processing of the current alternative route ends at final step 60. At this point, or after all threads have completed, rendering information may be applied, and the route and alternative routes may be embellished by helpful navigational information. For example, Dijkstra's algorithm can be applied to calculate times and distances from road junctions in the corridor to the destination. A route corridor map is computed based on the optimal and alternative routes.

### Identification of Deviations.

Referring again to FIG. 1, map server 23 identifies error-prone junctions from among candidates, typically using one or more of the following approaches:

Select all possible deviations from the optimal route between the origin and destination.

Evaluate junction characteristics, considering such factors as the number of intersecting roads at a junction, the angles between the roads and the size of the turn. For example, if a junction has more than four intersecting roads, the probability of a mistake becomes relatively high. All exits from a traffic circle could be included in the list of deviations.

Use statistical analysis of data collected from user experience with the junctions to identify deviations from a prescribed route. Data gathered from a large number of users and routes may indicate junctions where users often deviate from the route. The statistics may also contribute to the identification of common situations that lead to a mistake, not necessarily related to a specific place, e.g., junctions having particular configurations, a rapid succession of turns, confusing signage, and visual distractions.

Evaluate or use statistics to identify points where the user is likely to choose alternative routes intentionally. Statistics gathered from a large number of users and routes may indicate a popular alternative route to a destination. In cases where users may deliberately deviate from the main route, map server 23 identifies the deviations and adds them to the list of deviations. These deviations can also be time dependent. For example, during rush hours, users may deviate from the main route at a certain point in order to avoid a busy road.

Incorporate a known user driving profile, in which the profile reflects preferences for types of roads. Types of roads are sometimes referred to herein as “functional classes”. For example, some users commonly deviate to a highway. Other users commonly deviate to small streets. Some users have a tendency to miss an exit from a highway (in which case segments extending from all highway exits can be added to the list of deviations). Map server 23 (FIG. 1) may perform a statistical analysis of the user's driving habits including his actual deviations, in order to determine the user driving profile. Alternatively, client device 24 may allow the user to specify aspects of his driving profile, which are then communicated to map server 23 as part of the route request.

Use different combinations of the above-noted methods of selecting deviations along the main route according to different conditions, some of which are user-specific and others dependent on the road conditions. For example a road suitable for use only by all-terrain vehicles would be included or excluded as part of an optimal route according to the user's vehicle. Similarly, a route involving administrative obstacles, e.g., a military checkpoint, border control, or tollgate might be included or excluded according to the user's status of being in a favored or disfavored class. For example, a user may have priority at a tollgate by virtue of a transponder in his vehicle. Lacking such a device, he may be required to wait in lengthy queues to pay the toll manually.

Many different road factors may affect the identification of deviations. Highways and small roads have different sets of likely deviations. For example, on a highway a driver is relatively unlikely to execute a mistaken left turn.

Proximity of candidate junctions to one another is another factor. Thus, in a densely populated city, junctions may be particularly confusing if encountered in rapid succession. Here there is a relatively high probability that a driver will make two deviations in succession without returning to the prescribed route, resulting in a larger number of higher order deviations and alternative routes.

Time of day: according to the time of day along the main route, different methods may be used to select deviations. For example, during rush hours, the driving profile may be given more weight in selecting deviations.

Each of the factors and approaches described above can be weighted, and a combination chosen, for example using known multi-factor optimization algorithms. Map server 23 selects the method that scores the highest and uses it to determine the deviations. The weighting is highly application dependent.

In one alternative, weights can have predefined values. For example: 80% for ‘first order of deviation’, 10% for urban/highway areas, 5% for time of day, 5% for a user profile. Then a list of candidate deviations is collected and sorted by score. Using this approach, in one example, a first order of deviation would have relatively high score if it occurred in an urban area.

The assigned weights affect the sensitivity of the algorithm and the number of deviations that are ultimately identified. There is a tradeoff between sensitivity and the time and resources required to perform the computations. Thus, if the configuration results in an identification of too many deviations, latency in the preparation of a display for the user may become unacceptable. On the other hand if too few deviations are identified, then should the user deviate at a road junction that was ignored by the algorithm, further communication between the map server and client device would be necessary to prepare a new optimal route for the user. This is undesirable, as it would add to the load on the server.

### Implementation.

Deviations are typically stored as nodes and are associated with a directional property, in ascending order by distance from destination 104.

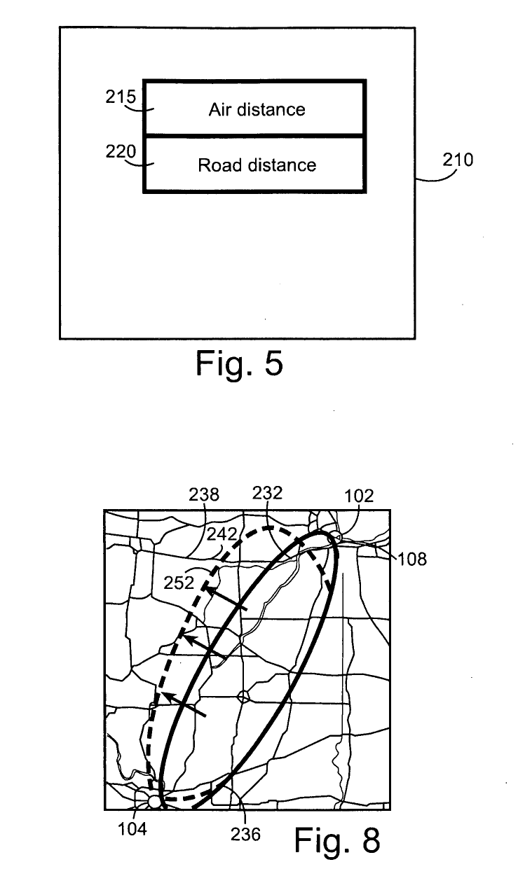

Reference is now made to FIG. 5, which is a block diagram of a node 210 used to construct a route corridor map, in accordance with an embodiment of the present invention. Each node represents a junction, which may be a junction that a deviation leads to in the list of likely deviations. Node 210 comprises data appropriate to execution of the search algorithm that operates in the “reverse direction”, that is beginning at the destination.

A field 215 contains the aerial distance from a selected likely deviation to the junction represented by node 210. This distance is used as the heuristic for the A* algorithm, as described above.

A field 220 contains a measure of the shortest distance by road, according to routes so far calculated, from the junction represented by node 210 to destination 104. The measure may incorporate a weight for various factors, e.g., turns on the route.

Node 210 may also contain other data fields (not shown) used in the calculation of routes from the junction represented by node 210 to destination 104.

In general, the A* algorithm may be applied by calculating nodes in either direction i.e., from initial node to goal node or vice versa, or it may be bi-directional, i.e., starting at both ends and meeting in the middle. When calculating alternative routes, map server 23 preferably calculates nodes from destination 104 towards the selected deviation, using roads that are traversed in the opposite direction only. This provides calculated routes from many nodes to destination 104, which can be reused when calculating best routes from other destinations. The reuse of data from nodes already calculated is important for the performance of the algorithm.

### Hierarchical Algorithm.

In one embodiment of the invention, map server 23 (FIG. 1) uses a variant of the A* algorithm, referred to herein as the “hierarchical A* algorithm”. It considers the functional class of a node or junction, which in turn depends on the functional class of roads intersecting at the junction. Functional classes comprise dynamic categories such as limited access highways, undivided highways, unimproved roads, etc.

In particular, the node may be disregarded as the A* algorithm progresses if the aerial distances of the node from a point of interest, e.g., origin, destination and other deviations are greater than a functional class-specific threshold, termed herein a “hierarchy radius” for the node's functional class. In some embodiments of the invention, map server 23 treats a node based on a junction in a previously calculated optimal route or alternative optimal route that fails to meet pre-determined criteria when identifying an optimal route as a new “point of interest” for use in establishing an additional hierarchy radius.

Furthermore, as map server 23 performs the A* algorithm, when dealing with areas remote from the destination, origin, and all deviations, only nodes having high hierarchy radii qualify for consideration. Conversely, the functional class requirement is relaxed as routes less remote from the destination, origin and deviations are calculated. Typical radii range from a few hundred of meters for roads with a low functional class, to hundreds of kilometers for roads with a high functional class.

In some embodiments of the invention, nodes may be expanded even if they are outside the ‘hierarchy radius’, for example if too few roads have been processed at the appropriate hierarchical level.

### EXAMPLE

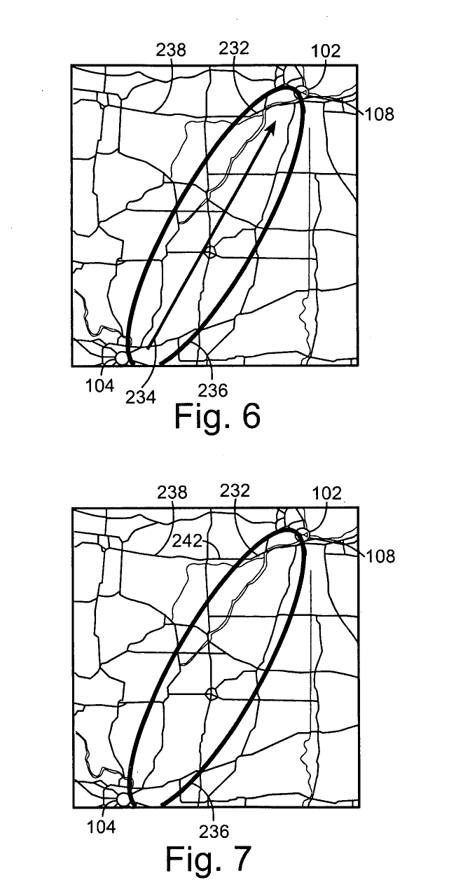

Reference is now made to FIG. 6, FIG. 7, and FIG. 8, which are maps that illustrate the above-described method of calculating alternative routes to optimal route 101, in accordance with an embodiment of the present invention.

FIG. 6 shows a map with a route 232 from origin 102 to destination 104 and illustrates a first phase of the A* algorithm. The A* algorithm operates generally from destination 104 toward junction 108, as indicated by an arrow 234, within an approximately elliptical region 236. Junction 108 is found on the deviation on route 232 that is most remote from destination 104. The algorithm processes optimal routes for deviations within region 236, as described above with respect to FIG. 2, builds a priority queue and remembers data for nodes calculated. Nodes outside region 236, for example a node represented by junction 238, are not processed at this stage. The deviation containing junction 108, being the most remote deviation, was chosen first by the A* algorithm. The A* algorithm then calculates nodes progressing from the destination 104 toward the deviation containing the junction 108. The A* algorithm thus operates directionally, and in general, most of the nodes that are calculated are within the region 236. While the elliptical shape of region 236 is representative of the operation of the A* algorithm, it is not a limitation. In some routes, less symmetric shapes are possible, depending on the spatial distribution of the nodes being calculated.

During the operation of the A* algorithm, a deviation other than the deviation containing the junction 108 may be encountered. This event eliminates a second calculation with respect to the other deviation, as an optimal alternative route from the destination to the other deviation has already been found.

Calculated nodes have two significant values: (1) the real distance or weight from the destination (real roads, turn costs etc.) and (2) aerial distance to the junction 108. The real distance, of course, remains fixed. However, the aerial distance may vary during operation of the A* algorithm as the priority queue reorders.

In FIG. 7, junction 242 is selected because (1) it is the next most remote deviation on route 232 and (2) it has not already been evaluated.

Map server 23 now rebuilds the priority queue. Each previously calculated node has values that include the ‘real weight’ from the destination (field 220, FIG. 5) and a ‘heuristic value’ (field 215) relative to the previous farthest deviation. The heuristic value of each such node is recalculated, using the aerial distance of the node to the new farthest deviation. This causes expanded nodes to reorder in the priority queue.

The A* algorithm is run again. The node expansion is continued in the direction of junction 242, as shown in FIG. 8. In this state, the A* algorithm uses data from previously calculated nodes within region 236. On completion, the optimal route to the junction 242, most deviations, and the alternative optimal routes are found in an approximately elliptical region 252.

The A* algorithm then iterates until all deviations are evaluated.

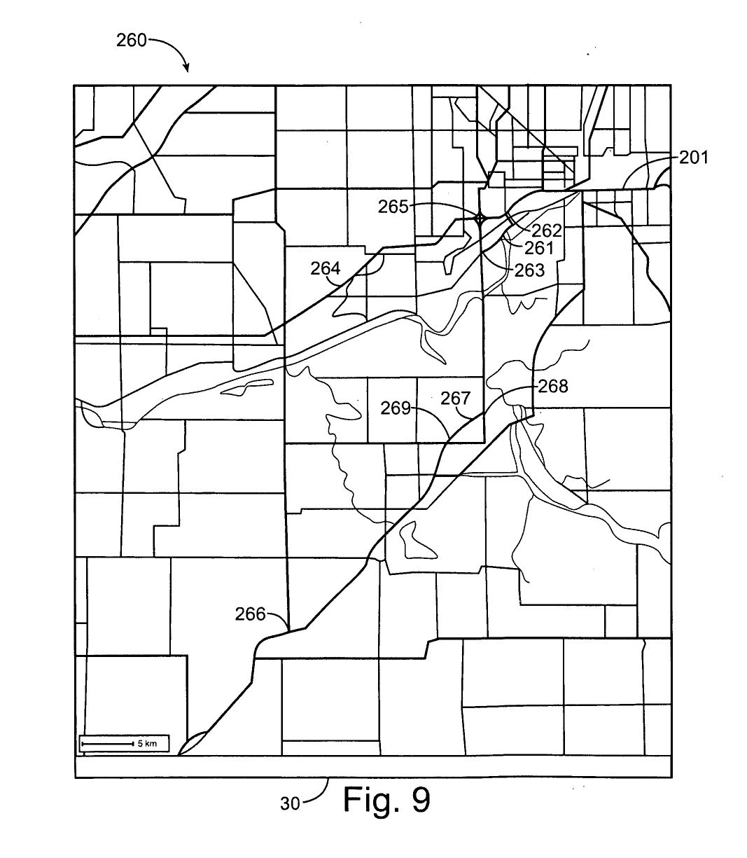

Reference is now made to FIG. 9, which is an overview of corridor map 260 of a part of optimal route 101, as shown on display 30, in accordance with an embodiment of the present invention. Overview corridor map 260 also shows an alternative route 261 from a junction 262 to a junction 263, an alternative route 264 from a junction 265 to a junction 266, and an alternative route 267 from a junction 268 to a junction 269.

Referring again to FIG. 2, computation of alternative optimal routes may be performed in several different ways, carrying out steps 49, 50, mutatis mutandis.

### ALTERNATIVE EMBODIMENT 1

An optimal route is computed from each identified deviation to the destination. This will result a relatively heavy computational load, particularly on routes having many deviations.

### ALTERNATIVE EMBODIMENT 2

In this embodiment, alternative routes are calculated, e.g., using the A* algorithm, in a forward direction from identified deviations that are chosen in a sort order according to proximity of the deviations to the destination. The real weights and lengths computed for each node are memorized. A disadvantage of this approach is that recalculation of alternative routes from previously unevaluated deviations does not reuse these weights. The advantage of reusability of the earlier calculation is largely lost.

### ALTERNATIVE EMBODIMENT 3

In this embodiment, reusability of nodes is exploited by concurrently undertaking alternative route calculations in both forward and reverse directions, for example in concurrent processes or threads. The advantage of the bi-directional approach is realized when roads developed from origin and destination rendezvous. In a first forward process or thread, the route search begins at the deviation and in a second at the destination. Eventually the two routes rendezvous. When a node evaluated by the second process or thread is discovered by the first one, the first process may use the weights that were calculated in previous iterations. This is because the previously calculated weights relate to the destination, which of course does not change. However, it is necessary that computed real weights of the first forward process be discarded and recomputed. This is accomplished following completion of a current iteration of the process, and upon initiation of the calculation of a deviation in a succeeding iteration.

### ALTERNATIVE EMBODIMENT 4

In this embodiment, alternative routes are computed in a reverse direction (from destination to deviation). However, the deviations are not sorted. While this avoids the computations required to perform a sort, the number of node calculations required to cover all deviation increases. This approach also requires repeated reordering of the priority queue, and reinitiating the A* algorithm.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method for preparing a route map, comprising the steps of:
communicating an origin and a destination to a server;
in said server establishing a prescribed route that extends from said origin to said destination and having junctions;
selecting deviations from said junctions where a traveler is likely to deviate from said prescribed route;
establishing alternative routes to said destination, said alternative routes extending from points of departure that are associated with said deviations, respectively;
thereafter downloading map data from said server to a client device, said map data comprising a route corridor that includes said prescribed route and said alternative routes; and
rendering at least a portion of said map data on said client device.

2. The method according to claim 1, wherein said alternative routes are optimal alternative routes.

3. The method according to claim 1, further comprising the steps of prior to performing said step of downloading map data, iterating said steps of selecting deviations and establishing alternative routes, respectively using said alternative routes as said prescribed route.

4. The method according to claim 1, wherein said step of establishing alternative routes is performed by choosing said deviations according to a sort order.

5. The method according to claim 4, wherein said sort order comprises remoteness of said deviations from said destination, wherein a first chosen one of said deviations is a most remote deviation from said destination, and said step of establishing alternative routes further comprises a search beginning at said destination and terminating at said points of departure, respectively.

6. The method according to claim 1, wherein step of selecting deviations comprises the steps of:
specifying points of interest; and
choosing said deviations only from ones of said junctions that are disposed within a predetermined distance of said points of interest.

7. The method according to claim 1, wherein said deviations comprise a first order of deviation on said prescribed route.

8. The method according to claim 1, wherein said deviations comprise a higher order of deviation on said alternative routes.

9. The method according to claim 1, further comprising the step of collecting records of actual deviations executed in at least a portion of said junctions; and selecting deviations is performed responsively to said records.

10. The method according to claim 1, further comprising the step of compiling a profile of said traveler, said profile including preferences for functional classes of roads, wherein selecting deviations is performed responsively to said profile.

11. The method according to claim 1, wherein said step of selecting deviations is performed responsively to proximity between a candidate junction and others of said junctions.

12. The method according to claim 1, wherein said step of selecting deviations is performed responsively to a number of intersecting roads at said junctions.

13. The method according to claim 1, wherein said step of selecting deviations is performed responsively to an angle of intersection at said junctions.

14. A computer software product for preparing a route map, including a tangible computer-readable medium in which computer program instructions are stored, which instructions, when read by a computer, cause the computer to receive an input comprising an origin and a destination, establish a prescribed route that extends from said origin to said destination and having junctions, select deviations from said junctions where a traveler is likely to deviate from said prescribed route, establish alternative routes to said destination, said alternative routes extending from points of departure that are associated with said deviations, respectively, thereafter download map data comprising a route corridor that includes said prescribed route and said alternative routes to a client device.

15. The computer software product according to claim 14, wherein said alternative routes are optimal alternative routes.

16. The computer software product according to claim 14, wherein said computer is further instructed to iterate selecting deviations and establishing alternative routes, prior to down-loading said map data and respectively using said alternative routes as said prescribed route.

17. The computer software product according to claim 14, wherein said computer is further instructed to establish said alternative routes by choosing said deviations according to a sort order.

18. The computer software product according to claim 17, wherein said sort order comprises remoteness of said deviations from said destination, wherein a first chosen one of said deviations is a most remote deviation from said destination, and wherein said computer is further instructed to establishing said alternative routes by execution of a search beginning at said destination and terminating at said points of departure, respectively.

19. The computer software product according to claim 14, wherein said computer is further instructed to select said deviations by specifying points of interest, and choosing said deviations only from ones of said junctions that are disposed within a predetermined distance of said points of interest.

20. A data processing system for preparing a route map, comprising:
a memory wherein computer program instructions are stored; and
a processor that accesses said memory to execute said instructions, wherein said instructions cause the processor to receive an input comprising an origin and a destination, and a prescribed route, said prescribed route extending from said origin to said destination and having junctions, select deviations from said junctions where a traveler is likely to deviate from said prescribed route, establish alternative routes to said destination, said alternative routes extending from points of departure that are associated with said deviations, respectively, thereafter download map data comprising establish a route corridor that includes said prescribed route and said alternative routes to a client device.

21. The data processing system according to claim 20, wherein said alternative routes are optimal alternative routes.

22. The data processing system according to claim 20, wherein said processor is further instructed to iterate selecting deviations and establishing alternative routes, prior to downloading said map data and respectively using said alternative routes as said prescribed route.

23. The data processing system according to claim 20, wherein said processor is further instructed to establish said alternative routes by choosing said deviations according to a sort order.

24. The data processing system according to claim 23, wherein said sort order comprises remoteness of said deviations from said destination, wherein a first chosen one of said deviations is a most remote deviation from said destination, and wherein said processor is further instructed to establishing said alternative routes by execution of a search beginning at said destination and terminating at said points of departure, respectively.

25. The data processing system according to claim 20, wherein said processor is further instructed to select said deviations by specifying points of interest, and choosing said deviations only from ones of said junctions that are disposed within a predetermined distance of said points of interest.
